(19) United States
(12) Patent Application Publication
(10) Pub. No.: US 2017/0217436 A1
(43) Pub. Date: Aug. 3, 2017

(54) DRIVING SUPPORT APPARATUS

(71) Applicant: TOYOTA JIDOSHA KABUSHIKI KAISHA, Toyota-shi (JP)

(72) Inventor: Ryo INOMATA, Oimachi (JP)

(73) Assignee: TOYOTA JIDOSHA KABUSHIKI KAISHA, Toyota-shi (JP)

(21) Appl. No.: 15/412,272

(22) Filed: Jan. 23, 2017

(30) Foreign Application Priority Data
Feb. 2, 2016 (JP) 2016-018370

(51) Int. Cl. B60W 30/16

(52) U.S. Cl. CPC B60W 30/16; B60W 2550/308; B60W 2550/302; B60W 2720/106

(57) ABSTRACT

A driving support apparatus is provided with: a first controller configured to generate a first acceleration request to accelerate a vehicle or a first deceleration request to decelerate the vehicle, on the basis of a predetermined reference speed or an inter-vehicle distance to a preceding vehicle; a second controller configured to generate a second deceleration request to decelerate the vehicle, on the basis of a lap rate between the vehicle and an obstacle that exists ahead of the vehicle; and a regulator configured to compare required deceleration of the first deceleration request and required deceleration of the second deceleration request in magnitude, and to output the deceleration request with higher required deceleration, if both of first deceleration control corresponding to the first deceleration request and second deceleration control corresponding to the second deceleration request are in a condition to be performed.

### CROSS-REFERENCE TO RELATED APPLICATIONS

This application is based upon and claims the benefit of priority of the prior Japanese Patent Application No. 2016-018370, filed on Feb. 2, 2016, the entire contents of which are incorporated herein by reference.

### BACKGROUND OF THE INVENTION

1. Field of the Invention Embodiments of the present invention relate to a driving support apparatus configured to support driving of a vehicle by a driver.

2. Description of the Related Art

For this type of apparatus, there is known an apparatus configured to perform a plurality of types of driving support controls according to various conditions. Japanese Patent Application Laid Open No. 2013-228928 discloses an apparatus provided with a plurality of driving support systems configured to issue a warning in accordance with each of the driver's consciousness deterioration, lane departure, and probability of collision with an obstacle. Particularly in this patent literature, there is proposed a technology in which if the issue of a warning by one driving support system is predicted, the issue of a warning by another driving support system with a lower priority than that of the one driving support system is prohibited.

In the technology described in the aforementioned patent literature, it is determined whether or not the driving support control is prohibited only on the basis of the priority of the respective driving operation systems. Thus, in some situations, the driving support control to be originally performed could not be appropriately performed.

Specifically, in the case of combined use of first control in which a vehicle is accelerated and decelerated to maintain a predetermined reference speed or an inter-vehicle distance and second control in which deceleration control is performed in accordance with a lap rate with the obstacle (i.e. a ratio of overlap between the vehicle and the obstacle), usually, the second control is set to have a higher priority than that of the first control. In this case, in the technology described in the aforementioned patent literature, if an execution condition of the second control is satisfied even during execution of the first control, the first control with a lower priority is stopped, and the second control with a higher priority is performed.

If, however, the deceleration of the first control is greater than the deceleration of the second control, the deceleration of the vehicle is reduced by switching the first control to the second control. In this case, the deceleration of the vehicle is controlled to be reduced in a situation in which the deceleration control is to be performed as the driving support control, and the driver wonders if inappropriate control is being performed and feels uncomfortable. As described above, in the technology described in the aforementioned patent literature, there is a possibility that the deceleration control cannot be appropriately performed depending on situations, which is technically problematic.

On the other hand, if the plurality of driving support controls are performed without using the preset priority, a question is how to select the control to be performed, when the controls have overlap of execution periods. In other words, if the priority is not set in advance, it is hardly possible to select which driving support control is to be performed without any index that replaces the priority. There could be thus such a technical problem that appropriate control cannot be performed even if the priority is not set.

### SUMMARY

In view of the aforementioned problems, it is therefore an object of embodiments of the present invention to provide a driving support apparatus configured to appropriately perform the deceleration control of the vehicle.

### 1

The above object of embodiments of the present invention can be achieved by a driving support apparatus provide with: a first controller configured to generate a first acceleration request to accelerate a vehicle or a first deceleration request to decelerate the vehicle, on the basis of a predetermined reference speed or an inter-vehicle distance to a preceding vehicle; a second controller configured to generate a second deceleration request to decelerate the vehicle, on the basis of a lap rate between the vehicle and an obstacle that exists ahead of the vehicle; and a regulator configured to compare required deceleration of the first deceleration request and required deceleration of the second deceleration request in magnitude, and to output the deceleration request with higher required deceleration, if both of first deceleration control corresponding to the first deceleration request and second deceleration control corresponding to the second deceleration request are in a condition to be performed.

According to the driving support apparatus in embodiments of the present invention, if both of the first deceleration control and the second deceleration control are in the condition to be performed, the required deceleration of the first deceleration request and the required deceleration of the second deceleration request are compared in magnitude, and the deceleration request with higher required deceleration is selectively outputted. As a result, the deceleration control with higher required deceleration is performed. It is thus possible to prevent that the deceleration control with lower required deceleration is performed and a driver of the vehicle feels uneasy due to a reduction in deceleration.

### 2

In one aspect of the driving support apparatus according to embodiments of the present invention, wherein said regulator does not output the first acceleration request but outputs the second deceleration request if both of first acceleration control corresponding to the first acceleration request and the second deceleration control are in a condition to be performed.

For example, if the second deceleration control is performed in priority to the first acceleration control and the first deceleration control, it is often configured in such a manner that the first acceleration control and the first deceleration control are stopped when the second deceleration control is performed. In contrast, in embodiments of the present invention, the deceleration control with higher required deceleration is selectively performed by regulation or adjustment. Thus, the first acceleration request and the second deceleration request are generated even when the second deceleration control is performed. This means that the acceleration by the first acceleration control and the deceleration by the second deceleration control are possibly performed at the same time even after the regulation of the deceleration. According to this aspect, however, if the second deceleration request is outputted, the first acceleration request is not outputted. This makes it possible to prevent that the acceleration control is performed at the same time as the deceleration control.

### 3

In one aspect of the driving support apparatus according to embodiments of the present invention, wherein said first controller is configured to switch between an operating state in which the first acceleration request and the first deceleration request are generated and a stop state in which the first acceleration request and the first deceleration request are not generated, and said regulator switches a state of said first controller from the operating state to the stop state if the required deceleration of the first deceleration request is less than the required deceleration of the second deceleration request as a result of the comparison in magnitude between the required deceleration of the first deceleration request and the required deceleration of the second deceleration request.

According to this aspect, the state of the first controller is switched from the operating state to the stop state, by which the generation of the first deceleration request on the first controller is stopped. By this, the second deceleration request with higher required deceleration is outputted from the regulator. It is thus possible to certainly prevent that the deceleration control with lower required deceleration is performed.

### 4

In the aspect in which the operating state and the stop state can be switched, the regulator may switch the state of the first controller from the operating state to the stop state if both of the first acceleration control and the second deceleration control are in the condition to be performed.

In this case, the state of the first controller is switched from the operating state to the stop state, by which the generation of the first acceleration request on the first controller is stopped. It is thus possible to prevent that the acceleration control is performed at the same time as the deceleration control.

### 5

In the aspect in which the operating state and the stop state can be switched, the state of the first controller may be switched between the operating state and the stop state by an operation of a driver of the vehicle, and the regulator may change target driving force, which is determined in accordance with the first acceleration request, to zero, until the second deceleration control is ended, while maintaining the first controller in the operating state, if both of the first acceleration control and the second deceleration control are in the condition to be performed.

In this case, even if the second deceleration control is to be performed, the first controller is not set in the stop state. It is therefore possible to save time and efforts for the driver resetting the first controller, which is set in the stop state, to be in the operating state.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram illustrating a configuration of a driving support apparatus according to a first embodiment;

FIG. 2 is a conceptual diagram illustrating active cruise control if there is no preceding vehicle;

FIG. 3 is a conceptual diagram illustrating active cruise control if there is a preceding vehicle;

FIG. 4 is a conceptual diagram illustrating a method of calculating a lap rate between a self-vehicle and a stopped vehicle;

FIG. 5 is a time chart illustrating brake timing in pre-crash safety control according to a comparative example;

FIG. 6 is a time chart illustrating brake timing in pre-crash safety control according to the first embodiment;

FIG. 7 is a flowchart illustrating operations of a driving support apparatus according to the comparative example;

FIG. 8 is a flowchart illustrating operations regarding regulation or adjustment of deceleration on the driving support apparatus according to the first embodiment;

FIG. 9 is a block diagram illustrating a configuration of a driving support apparatus according to a second embodiment;

FIG. 10 is a block diagram illustrating a configuration of a driving support apparatus according to a third embodiment;

FIG. 11 is a flowchart illustrating operations regarding regulation or adjustment of deceleration on the driving support apparatus according to the third embodiment;

FIG. 12 is a block diagram illustrating a configuration of a driving support apparatus according to a fourth embodiment;

FIG. 13 is a flowchart illustrating operations regarding regulation or adjustment of deceleration on the driving support apparatus according to the fourth embodiment; and

FIG. 14 is a flowchart illustrating operations regarding driving force control on the driving support apparatus according to the fourth embodiment.

### DETAILED DESCRIPTION OF THE PREFERRED EMBODIMENTS

A driving support apparatus according to embodiments of the present invention will be explained with reference to the drawings. Hereinafter, an explanation will be given by exemplifying four embodiments, which are a first embodiment to a fourth embodiment.

### (1) First Embodiment

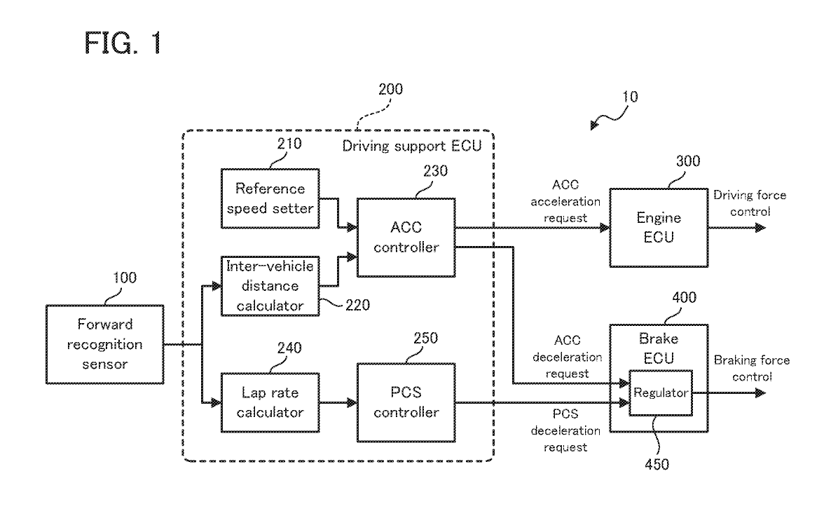

A driving support apparatus according to a first embodiment will be explained with reference to FIG. 1 to FIG. 8. Hereinafter, an explanation will be given in order, for a configuration of the driving support apparatus according to the first embodiment, an outline of active cruise control, an outline of pre-crash safety control, possible problems in combined use of the two driving support controls, operations of the driving support apparatus according to the first embodiment, and technical effects achieved by the driving support apparatus according to the first embodiment.

### (1-1) Configuration of Driving Support Apparatus

Firstly, the configuration of the driving support apparatus according to the first embodiment will be explained with reference to FIG. 1. FIG. 1 is a block diagram illustrating the configuration of the driving support apparatus according to the first embodiment.

In FIG. 1, a driving support apparatus 10 according to the first embodiment is mounted on a vehicle, such as an automobile, and is configured to perform driving support control for supporting driving by a driver. The driving support apparatus 10 is provided with a forward recognition sensor 100, a driving support electronic control unit (ECU) 200, an engine ECU 300, and a brake ECU 400.

The forward recognition sensor 100 is provided, for example, with an in-vehicle camera, a radar, and the like, and is a sensor configured to recognize a preceding vehicle or an obstacle that exists ahead of the vehicle. Information about the preceding vehicle or the obstacle recognized by the forward recognition sensor 100 is outputted to each of an inter-vehicle distance calculator 220 and a lap rate calculator 240 of the driving support ECU 200.

The driving support ECU 200 is a controller configured to perform various processes regarding the driving support control of the vehicle, and is provided with a reference speed setter 210, the inter-vehicle distance calculator 220, an active cruise control (ACC) controller 230, a lap rate calculator 240, and a pre-crash safety (PCS) controller 250.

The reference speed setter 210 is configured to set a reference speed of active cruise control (ACC) (hereinafter referred to as “ACC control” as occasion demands) performed by the ACC controller 230. The reference speed may be arbitrarily set by the operation of the driver, or may be automatically set in accordance with a running situation or the like. The reference speed set on the reference speed setter 210 is outputted to the ACC controller 230, as occasion demands.

The inter-vehicle distance calculator 220 is configured to calculate an inter-vehicle distance between a self-vehicle (i.e. the vehicle on which the driving support apparatus 10 according to the embodiment is mounted) and the preceding vehicle, on the basis of the information obtained from the forward recognition sensor 100. The inter-vehicle distance calculated on the inter-vehicle distance calculator 220 is outputted to the ACC controller 230, as occasion demands.

The ACC controller 230 is configured to perform various processes regarding the ACC control, on the basis of the reference speed set on the reference speed setter 210 and the inter-vehicle distance calculated on the inter-vehicle distance calculator 220. Specifically, the ACC controller 230 is configured to generate an ACC acceleration request and output it to the engine ECU 300 if the vehicle is to be accelerated, and is configured to generate an ACC deceleration request and output it to the brake ECU 400 if the vehicle is to be decelerated. The ACC controller 230 is one specific example of the “first controller”. The ACC acceleration request and the ACC deceleration request are respectively one specific example of the “first acceleration request” and the “first deceleration request”.

The lap rate calculator 240 is configured to calculate a lap rate between the self-vehicle and the obstacle that exists ahead (i.e. a ratio of overlap between the self-vehicle and the obstacle in a vehicle width direction), on the basis of the information obtained from the forward recognition sensor 100. A specific method of calculating the lap rate will be described in detail later. The lap rate calculated on the lap rate calculator 240 is outputted to the PCS controller 250, as occasion demands.

The PCS controller 250 is configured to perform various processes regarding pre-crash safety control (hereinafter referred to as “PCS control” as occasion demands) for avoiding collision of the vehicle. Specifically, the PCS controller 250 is configured to generate a PCS deceleration request and output it to the brake ECU 400 in accordance with possibility/probability of collision between the self-vehicle and the obstacle. Moreover, the PCS controller 250 according to the embodiment is particularly configured to perform the PCS control on the basis of the lap rate calculated on the lap rate calculator 240. The PCS control will be described in detail later. The PCS controller 250 is one specific example of the “second controller”. The PCS deceleration request is one specific example of the “second deceleration request”.

The engine ECU 300 is a controller configured to control acceleration (in other words, driving force) of the vehicle. Moreover, the engine ECU 300 according to the embodiment is particularly configured to control the driving force of the vehicle on the basis of the ACC acceleration request outputted from the ACC controller 230. The engine ECU 300 is configured to adjust an opening degree of a throttle valve of an engine (not-illustrated), which is a power source of the vehicle, thereby controlling the driving force of the vehicle. If the vehicle is a hybrid vehicle or an electric vehicle, which is provided with a motor as the power source, the engine ECU 300 may control operations of the motor in addition to or instead of the engine, thereby controlling the driving force of the vehicle.

The brake ECU 400 is a controller configured to control deceleration (in other words, braking force) of the vehicle. Moreover, the brake ECU 400 according to the embodiment is particularly configured to control the braking force of the vehicle on the basis of the ACC deceleration request outputted from the ACC controller 230, or on the basis of the PCS deceleration request outputted from the PCS controller 250. The brake ECU 400 is configured to automatically control, for example, a hydraulic brake of the vehicle, thereby controlling the braking force of the vehicle. Alternatively, the brake ECU 400 may control a regenerative brake using the motor or the like, thereby controlling the braking force of the vehicle.

### (1-2) Active Cruise Control

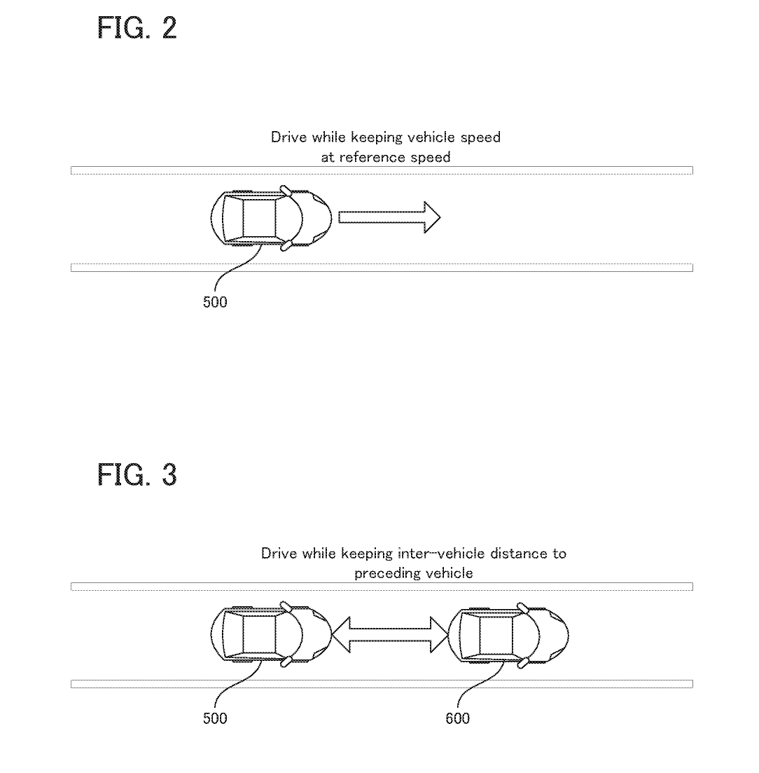

Next, the ACC control performed by the ACC controller 230 described above will be explained in detail with reference to FIG. 2 and FIG. 3. FIG. 2 is a conceptual diagram illustrating the active cruise control if there is no preceding vehicle. FIG. 3 is a conceptual diagram illustrating the active cruise control if there is a preceding vehicle.

As illustrated in FIG. 2, in the ACC control, a self-vehicle 500 is controlled to keep the reference speed set on the reference speed setter 210 if there is no preceding vehicle ahead of the self-vehicle 500. Specifically, if the speed of the self-vehicle 500 is greater than the reference speed, the ACC deceleration request is outputted from the ACC controller 230, and the braking force of the self-vehicle 500 is controlled by the brake ECU 400. On the other hand, if the speed of the self-vehicle 500 is less than or equal to the reference speed, the ACC acceleration request is outputted from the ACC controller 230, and the driving force of the self-vehicle 500 is controlled by the engine ECU 300.

As illustrated in FIG. 3, in the ACC control, the self-vehicle 500 is controlled to keep an inter-vehicle distance to a preceding vehicle 600 at a predetermined distance if there is the preceding vehicle 600 ahead of the self-vehicle 500. The predetermined distance may be stored by the ACC controller 230 in advance, or may be set by a driver of the self-vehicle 500 or the like, as occasion demands. If the inter-vehicle distance between the self-vehicle 500 and the preceding vehicle 600 is less than or equal to the predetermined distance, the ACC deceleration request is outputted from the ACC controller 230, and the braking force of the self-vehicle 500 is controlled by the brake ECU 400. On the other hand, if the inter-vehicle distance between the self-vehicle 500 and the preceding vehicle 600 is greater than the predetermined distance, the ACC acceleration request is outputted from the ACC controller 230, and the driving force of the self-vehicle 500 is controlled by the engine ECU 300.

As described above, in the ACC control, acceleration control or deceleration control of the self-vehicle 500 is automatically performed in accordance with the reference speed or the inter-vehicle distance to the preceding vehicle 600. Whether or not to perform the ACC control can be set by the driver or the like, as occasion demands.

### (1-3) Pre-crash Safety Control

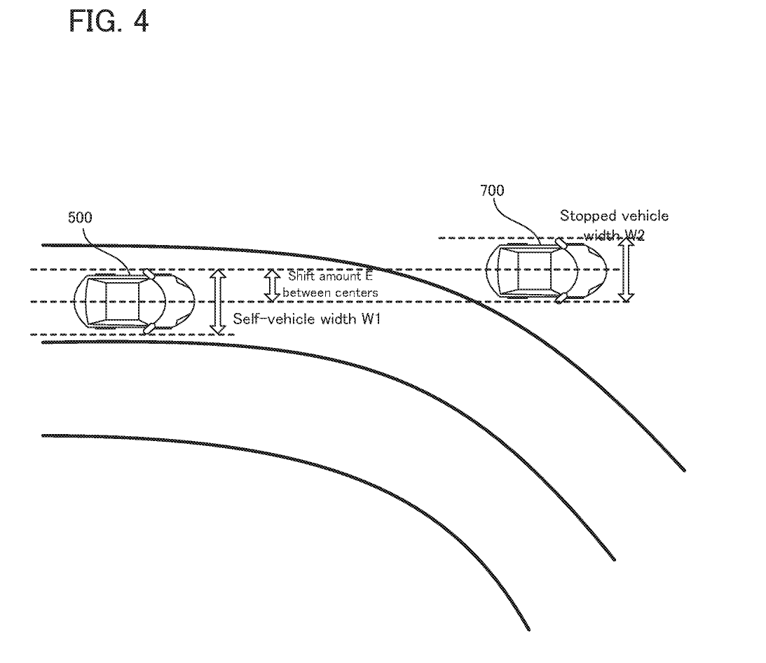

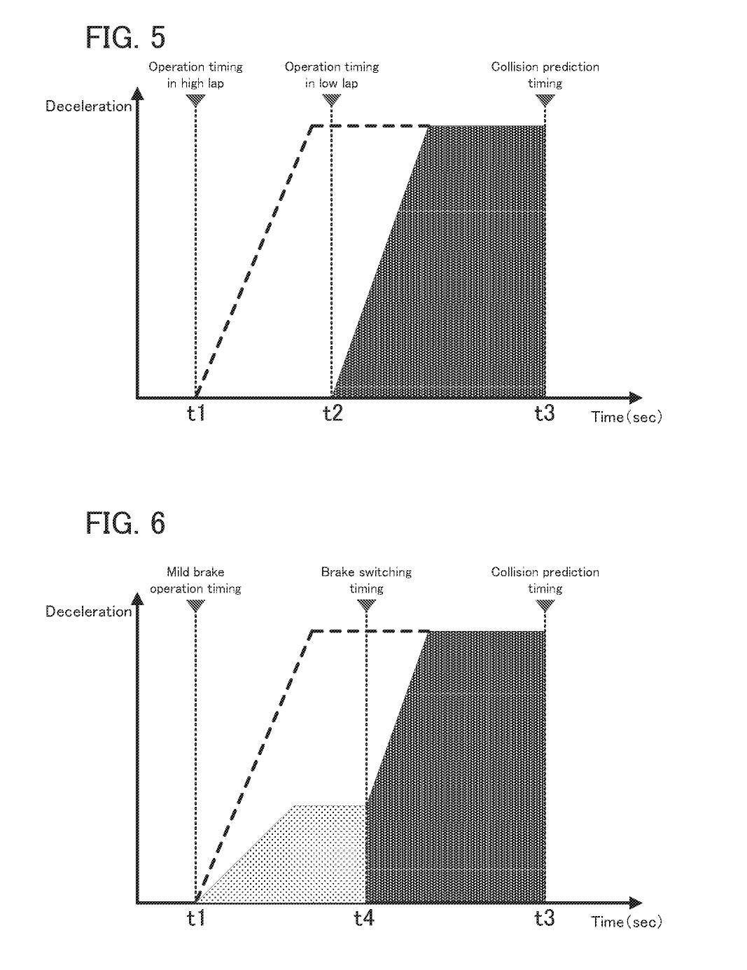

Next, the PCS control performed by the PCS controller 250 described above will be explained in detail with reference to FIG. 4 to FIG. 6. FIG. 4 is a conceptual diagram illustrating a method of calculating a lap rate between a self-vehicle and a stopped vehicle. FIG. 5 is a time chart illustrating brake timing in the pre-crash safety control according to a comparative example. FIG. 6 is a time chart illustrating brake timing in the pre-crash safety control according to the first embodiment.

The PCS control is automatic deceleration control performed to avoid the collision with the obstacle that exists ahead of the vehicle. If an operating state of the PCS control is ON, the presence of the obstacle that exists ahead of the vehicle is monitored on the forward recognition sensor 110. If the obstacle is recognized, the PCS deceleration request is outputted from the PCS controller 250, on the basis of the possibility of the collision with the obstacle. This allows the vehicle to be automatically decelerated, and makes it possible to preferably avoid the collision with the obstacle.

Moreover, particularly in the embodiment, the PCS control is performed on the basis of the lap rate with respect to the obstacle that exists ahead of the vehicle. Specifically, timing of the deceleration control is changed in accordance with the lap rate. Moreover, in a low lap in which the lap rate is lower than a predetermined threshold value, mild brake control (hereinafter, referred to as “PCS mild brake control”, as occasion demands) is performed. Hereinafter, the PCS control based on the lap rate will be specifically explained.

As illustrated in FIG. 4, suppose that there is a stopped vehicle 700 ahead of the self-vehicle 500 that is driving along a curve, as an example. In this case, when it is seen from the self-vehicle 500, the stopped vehicle 700 is an obstacle that exists ahead. Thus, if the operating state of the PCS control is ON, a lap rate between the self-vehicle 500 and the stopped vehicle 700 is firstly calculated on the lap rate calculator 240.

The lap rate is calculated as the degree of overlap between the self-vehicle 500 and the stopped vehicle 700 in the vehicle width direction. Here, if the vehicle width of the self-vehicle 500 is W1, the vehicle width of the stopped vehicle 700 is W2, the shift amount of central positions of the self-vehicle 500 and the stopped vehicle 700 is E, then, a lap rate R can be calculated by using the following numerical expression (1).

R={(W1+W2)/2−E}/W1 (1)

The numerical expression (1) is merely one example of the method of calculating the lap rate R. The numerical expression (1) does not need to be used if the lap rate R can be calculated in another method.

If the lap rate R is calculated, timing of the deceleration control to be performed (i.e. operation timing of the brake) is determined on the basis of the lap rate R. Specifically, if the calculated lap rate R is relatively high, the timing of the deceleration control to be performed is determined to be relatively early. This is because the possibility of the collision with the obstacle is estimated to be high if the lap rate R is high. On the other hand, if the calculated lap rate R is relatively low, the timing of the deceleration control to be performed is determined to be relatively late. This is because the possibility of the collision is estimated to be low if the lap rate R is low, even if there is the obstacle ahead.

In the comparative example illustrated in FIG. 5, the operation timing of the brake is changed on the basis of the lap rate R, as described above. Specifically, in a high lap (i.e. if the lap rate is high), the brake operation timing is set to t1, which is relatively early. By virtue of such control, even if there is the obstacle having a high collision possibility, the deceleration can be performed well before a collision prediction timing t3. On the other hand, in the low lap (i.e. if the lap rate is low), the brake operation timing is set to t2, which is later than t1. By virtue of such control, it is possible to prevent that significant deceleration is performed on the obstacle having a low collision possibility.

In the aforementioned comparative example, however, because the brake operation timing in the low lap is set to be late, sudden deceleration is required if the vehicle collides with the obstacle even though the lap rate is low. In order to solve such a problem, in the PCS control according to the embodiment, if the lap rate is low, PCS mild brake control, which is milder than the normal brake control, is performed without delaying the brake operation timing.

In FIG. 6, in the PCS control according to the embodiment, even in the low lap, the deceleration control is started from the brake operation timing t1 in the high lap illustrated in FIG. 5. Here, the deceleration control started from the timing t1 is the aforementioned PCS mild brake control. The start timing of the PCS mild brake control does not necessarily match the brake operation timing t1 in the high lap, and may be any timing that is earlier than the brake operation timing t2 in the low lap illustrated in FIG. 5.

During the PCS mild brake control, for example, if it is determined that the collision possibility becomes higher due to a change in the lap rate or the like, the PCS mild brake control is switched to the normal brake control (i.e. the brake control with higher braking force) (refer to a brake switching timing t4 in FIG. 6). By switching the brake control in this manner, it is possible to decelerate the self-vehicle 500 and to avoid the collision, even though the collision possibility becomes higher from a situation with the low lap rate. Particularly in the embodiment, the PCS mild brake control is performed at an early stage. It is thus possible to reduce a change in the deceleration when the brake control is switched. In other words, in comparison with the comparative example illustrated in FIG. 5, smoother deceleration control can be realized.

### (1-4) Problem due to Combined Use of Driving Support Controls

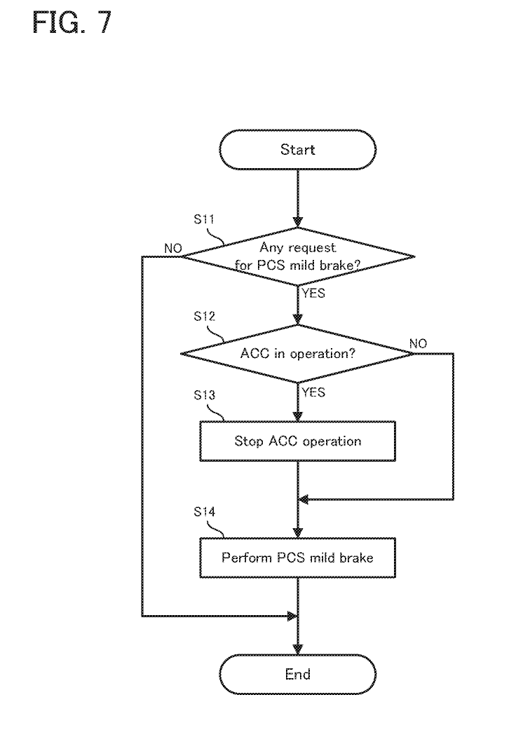

Next, a possible problem in the case of combined use of the ACC control and the PCS control described above will be specifically explained with reference to FIG. 7. FIG. 7 is a flowchart illustrating operations of a driving support apparatus according to the comparative example.

In FIG. 7, on the driving support apparatus according to the comparative example, if the PCS mild brake control is required (step S11: YES), it is determined whether or not the ACC control is in operation (step S12). In other words, it is determined whether or not the ACC acceleration request and the ACC deceleration request are outputted from the ACC controller 230. If the PCS mild brake control is not required (step S11: NO), processes after the step S12 will be omitted.

If it is determined that the ACC control is in operation (the step S12: YES), the operation of the ACC control is stopped (step S13), and the PCS mild brake control is performed (step S14). On the other hand, if it is determined that the ACC control is not in operation (the step S12: NO), the process in the step S13 is omitted, and the PCS middle brake control is performed (step S14). In other words, the PCS mild brake control is performed while the operation of the ACC control is stopped. This is because the priority of the PCS control is set to be higher than that of the ACC control.

If, however, the PCS control is always performed in priority to the ACC control, there arises an unexpected detrimental effect in some cases. Specifically, if the deceleration in the PCS mild brake control is less than the deceleration by the ACC control, the ACC control is stopped and the PCS mild brake control is started, by which the deceleration is reduced. Since the deceleration is reduced in a situation in which the deceleration control is to be performed, the driver possibly feels uneasy due to so-called gravity (G) slip.

The driving support apparatus 10 according to the embodiment is configured to perform the operations, which will be explained in detail later, in order to avoid the aforementioned problem. In the following explanation, for convenience, it is assumed that all the deceleration controls according to the PCS control are the PCS mild brake control.

### (1-5) Operations of Driving Support Apparatus

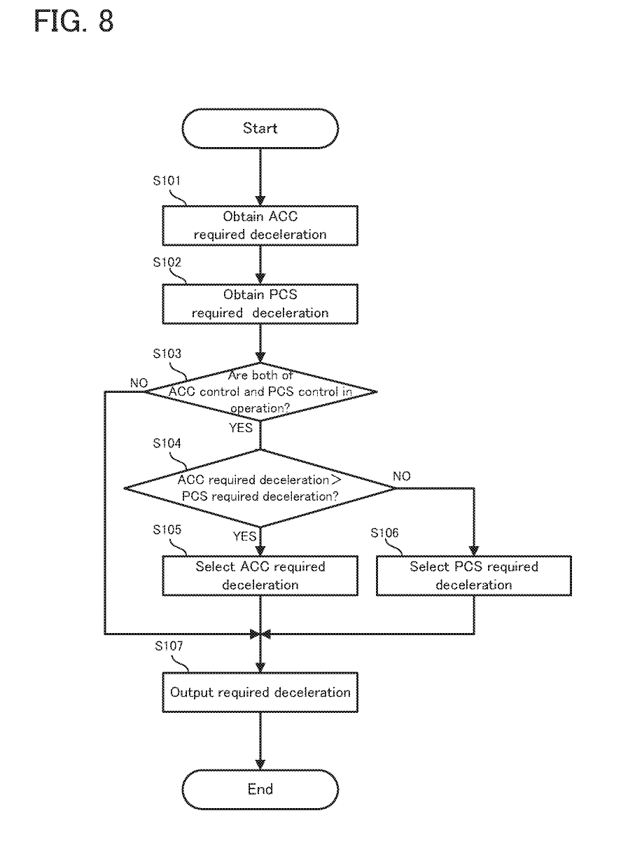

Hereinafter, the operations of the driving support apparatus 10 according to the first embodiment will be explained in detail with reference to FIG. 8. FIG. 8 is a flowchart illustrating operations regarding regulation or adjustment of deceleration on the driving support apparatus according to the first embodiment. The process illustrated in the flowchart in FIG. 8 is a process performed by a regulator 450 of the brake ECU 400.

In FIG. 8, according to the driving support apparatus 10 in the first embodiment, as the driving support control, the ACC control by the ACC controller 230 and the PCS control by the PCS controller 250 can be performed in parallel. In this case, the ACC deceleration request and the PCS deceleration request are respectively outputted from the ACC controller 230 and the PCS controller 250, to the brake ECU 400.

On the brake ECU 400, each of the ACC deceleration request and the PCS deceleration request is obtained on the regulator 450 (steps S101, S102). On the regulator 450, it is determined whether or not both of the deceleration control according to the obtained ACC deceleration request and the deceleration control according to the obtained PCS deceleration request are in operation (step S103). In other words, it is determined whether or not both of the deceleration control according to the obtained ACC deceleration request and the deceleration control according to the obtained PCS deceleration request are in a condition to be performed.

Specifically, the regulator 450 determines that both of the deceleration control according to the obtained ACC deceleration request and the deceleration control according to the obtained PCS deceleration request are in operation if the PCS deceleration request is obtained during operation of the ACC control. Alternatively, the regulator 450 determines that both of the deceleration control according to the obtained ACC deceleration request and the deceleration control according to the obtained PCS deceleration request are in operation if the ACC deceleration request and the PCS deceleration request are obtained at substantially the same time point.

Moreover, the regulator 450 may determine whether or not the obtained ACC deceleration request and the obtained PCS deceleration request require that the deceleration controls should be performed at the same time at least in a partial period. Even in this case, substantially the same determination is performed as when both of the ACC deceleration request and the PCS deceleration request are in operation.

The “execution period” herein means a period in which the driving force according to the acceleration control or the braking force according to the deceleration control is actually generated in the self-vehicle 500.

If it is determined that both of the deceleration control according to the ACC deceleration request and the deceleration control according to the PCS deceleration request are not in operation (the step S103: NO), required deceleration according to the ACC deceleration request (hereinafter referred to as “ACC required deceleration”, as occasion demands) and required deceleration according to the PCS deceleration request (hereinafter referred to as “PCS required deceleration”, as occasion demands) are outputted from the regulator 450 (step S107), because the deceleration control according to the ACC deceleration request and the deceleration control according to the PCS deceleration request may be separately performed. This allows braking force control of the self-vehicle 500 to be performed, as occasion demands, and allows the self-vehicle 500 to be decelerated.

On the other hand, if it is determined that both of the deceleration control according to the ACC deceleration request and the deceleration control according to the PCS deceleration request are in operation (the step S103: YES), it is determined whether or not the ACC required deceleration is greater than the PCS required deceleration (step S104). Then, if it is determined that the ACC required deceleration is greater than the PCS required deceleration (the step S104: YES), the ACC required deceleration is selected on the regulator 450 (step S105), and is outputted as the required deceleration of the deceleration control to be performed (step S107). Thus, in this case, the ACC control is performed in priority to the PCS control. On the other hand, if it is determined that the ACC required deceleration is less than or equal to the PCS required deceleration (the step S104: NO), the PCS required deceleration is selected on the regulator 450 (step S106), and is outputted as the required deceleration of the deceleration control to be performed (the step S107). Thus, in this case, the PCS control is performed in priority to the ACC control.

In the comparative example explained in FIG. 7, the operation of the ACC control is stopped when the PCS mild brake control is performed. In contrast, on the driving support apparatus 10 according to the embodiment, the operation of the ACC control is not stopped even when the PCS mild brake control is performed (i.e. the ACC controller 230 keeps operating).

### (1-6) Effects of Embodiment

Next, the beneficial technical effects achieved by the driving support apparatus 10 according to the first embodiment will be explained in detail.

As explained in FIG. 8, according the driving support apparatus 10 in the first embodiment, if both of the deceleration control in the ACC control and the deceleration control in the PCS control are in operation, the deceleration control with higher required deceleration is performed. In other words, unlike the comparative example explained in FIG. 7 in which the PCS control is always performed in priority to the ACC control, it is determined which of the deceleration controls is to be performed in accordance with the respective required decelerations. If the deceleration control to be performed is selected in this manner, it is possible to prevent that the deceleration control with lower required deceleration is performed and the driver feels uneasy due to the gravity (G) slip.

Moreover, in the embodiment, the ACC control is not stopped even when the PCS control is performed (i.e. the control according to the ACC deceleration request is temporarily suspended, but the ACC deceleration request is continuously generated even thereafter). Thus, if the ACC control is to be performed in priority to the PCS control, the ACC control can be performed, and the acceleration/deceleration of the vehicle can be more preferentially controlled.

The normal PCS deceleration request is outputted so that the required deceleration is relatively high in order to avoid the collision. It is therefore hard to think that the required deceleration is less in the PCS deceleration request than in the ACC deceleration request. As explained in the embodiment, however, the PCS mild brake control is performed depending on the lap rate. It is thus considered that the required deceleration is likely less in the PCS deceleration request than in the ACC deceleration request in many situations. Therefore, the aforementioned technical effects are remarkably demonstrated.

### (2) Second Embodiment

Next, a driving support apparatus according to a second embodiment will be explained. The second embodiment is mostly the same as, but is partially different from the already explained first embodiment in configuration and operations. Thus, hereinafter, the different part from the first embodiment will be explained in detail, and an explanation for the other same part will be omitted. Hereinafter, an explanation will be given in order, for a configuration of the driving support apparatus according to the second embodiment and effects achieved by the driving support apparatus according to the second embodiment.

### (2-1) Configuration of Driving Support Apparatus

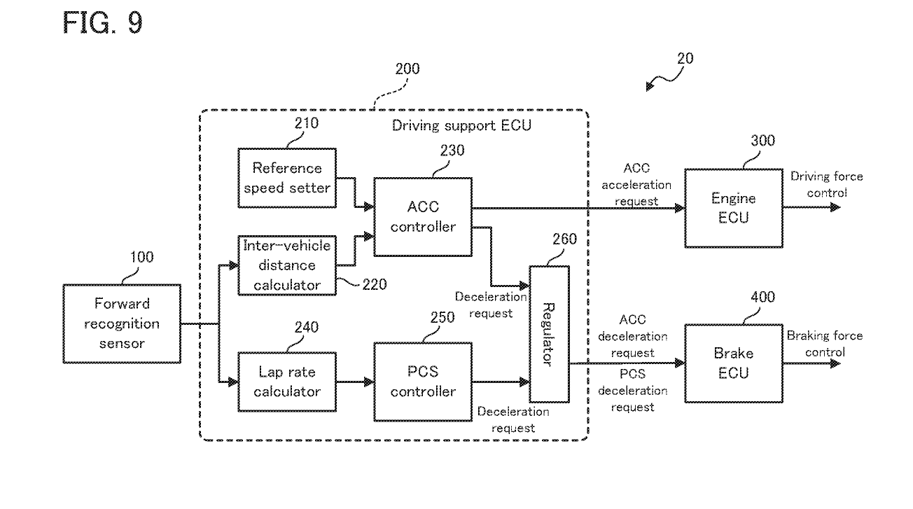

Firstly, the configuration of the driving support apparatus according to the second embodiment will be explained with reference to FIG. 9. FIG. 9 is a block diagram illustrating the configuration of the driving support apparatus according to the second embodiment.

In FIG. 9, a driving support apparatus 20 according to the second embodiment is different from the driving support apparatus 10 according to the first embodiment in position of the regulator. Specifically, in the first embodiment, the regulator is configured as the regulator 450 provided for the brake ECU 400 (refer to FIG. 1). In the second embodiment, the regulator is configured as a regulator 260 provided for the driving support ECU 200.

The regulator 260 according to the second embodiment is configured in such a manner that the ACC deceleration request outputted from the ACC controller 230 and the PCS deceleration request outputted from the PCS controller 250 are inputted to the regulator 260. The regulator 260 is configured to output the deceleration request with higher required deceleration to the brake ECU 400 if both of the deceleration control according to the ACC deceleration request and the deceleration control according to the PCS deceleration request are in operation. Specific processing content of the regulator 260 is the same as that in the first embodiment illustrated in FIG. 8. Thus, a more detailed explanation will be omitted here.

The brake ECU 400 is configured to control the braking force of the self-vehicle 500 in accordance with the deceleration request outputted from the regulator 260. In the second embodiment, even if both of the deceleration control according to the ACC deceleration request and the deceleration control according to the PCS deceleration request are in operation, any of the deceleration requests is selected before the deceleration requests are inputted to the brake ECU 400 (i.e. on the regulator 260 of the driving support ECU 200). Thus, there is no need for the brake ECU 400 to compare the required decelerations of the inputted deceleration requests.

### (2-2) Effects of Embodiment

Next, the beneficial technical effects achieved by the driving support apparatus 20 according to the second embodiment will be explained in detail.

As explained in FIG. 9, according the driving support apparatus 20 in the second embodiment, even if both of the deceleration control according to the ACC deceleration request and the deceleration control according to the PCS deceleration request are in operation, the deceleration request with lower required deceleration is selected on the regulator 260 of the driving support ECU 200. Therefore, as in the already explained first embodiment, it is possible to prevent that the deceleration control with lower required deceleration is performed and the driver feels uneasy due to the gravity (G) slip.

### (3) Third Embodiment

Next, a driving support apparatus according to a third embodiment will be explained. The third embodiment is mostly the same as, but is partially different from the already explained first and second embodiments in configuration and operations. Thus, hereinafter, the different part from the first and second embodiments will be explained in detail, and an explanation for the other same part will be omitted. Hereinafter, an explanation will be given in order, for a configuration of the driving support apparatus according to the third embodiment, operations of the driving support apparatus according to the third embodiment, and effects achieved by the driving support apparatus according to the third embodiment.

### (3-1) Configuration of Driving Support Apparatus

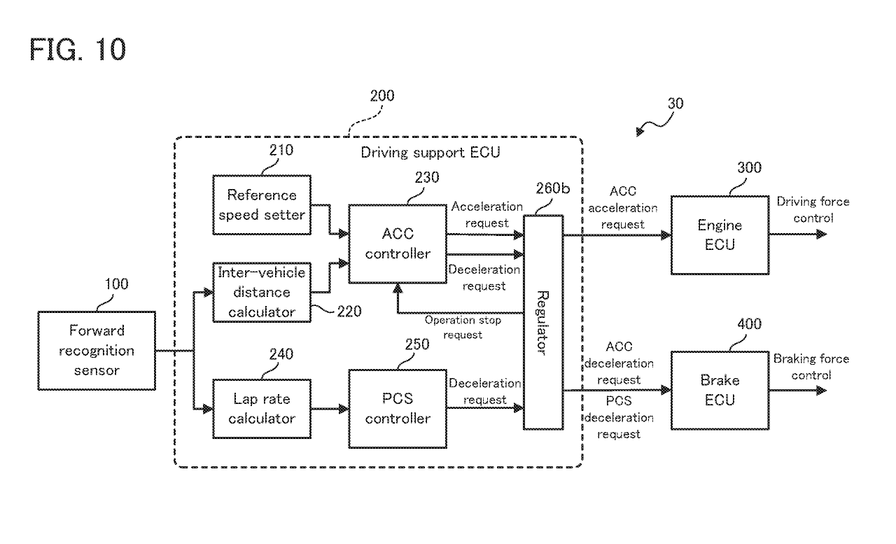

Firstly, the configuration of the driving support apparatus according to the third embodiment will be explained with reference to FIG. 10. FIG. 10 is a block diagram illustrating the configuration of the driving support apparatus according to the third embodiment.

In FIG. 10, in a driving support apparatus 30 according to the third embodiment, the driving support ECU 200 is provided with a regulator 260b, as in the second embodiment. The regulator 260b according to the third embodiment, however, is partially different from the regulator 260 according to the second embodiment in configuration (refer to FIG. 9). Specifically, the regulator 260b is configured in such a manner that not only the ACC deceleration request outputted from the ACC controller 230 and the PCS deceleration request outputted from the PCS controller 250 but also the ACC acceleration request outputted from the ACC controller 230 are inputted to the regulator 260b. The regulator 260b is configured not only to output the ACC deceleration request and the PCS deceleration request to the brake ECU 400, but also to output the ACC acceleration request to the engine ECU 300.

Moreover, the regulator 260b according to the third embodiment is also configured to output an operation stop request (i.e. a request to stop the operation of the ACC control) to the ACC controller 230. The operation stop request outputted by the regulator 260b will be described in detail in the following explanation regarding the operations.

### (3-2) Operations of Driving Support Apparatus

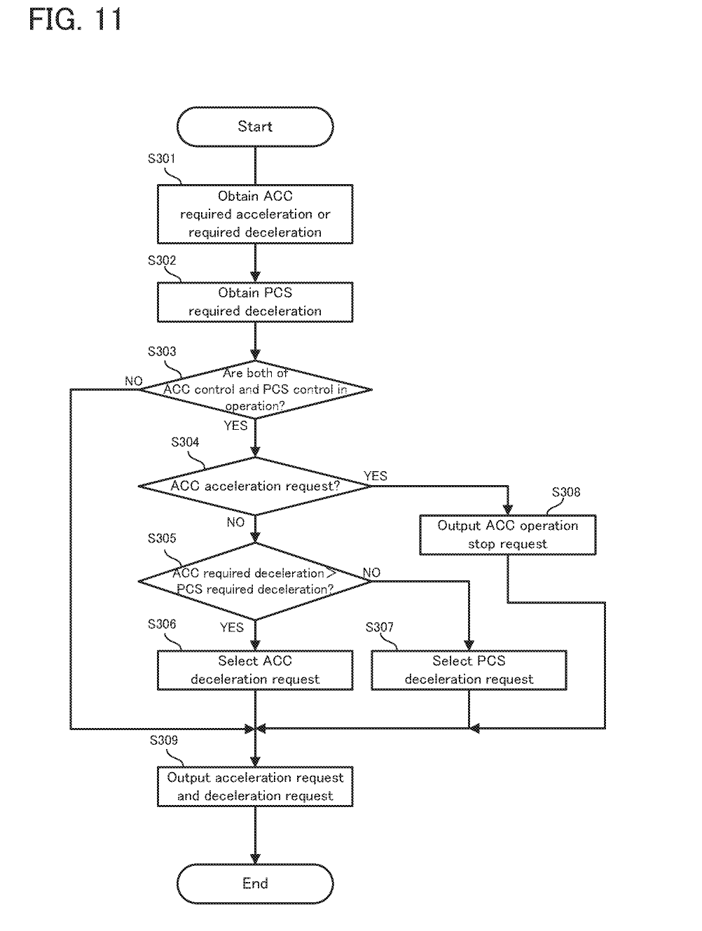

Hereinafter, the operations of the driving support apparatus 30 according to the third embodiment will be explained in detail with reference to FIG. 11. FIG. 11 is a flowchart illustrating operations regarding regulation or adjustment of deceleration on the driving support apparatus according to the third embodiment. The process illustrated in the flowchart in FIG. 11 is a process performed by the regulator 260b of the driving support ECU 200.

In FIG. 11, in operation of the driving support apparatus 30 according to the third embodiment, each of the ACC acceleration request and the ACC deceleration request outputted from the ACC controller 230 is obtained on the regulator 260b (step S301). Moreover, the PCS deceleration request outputted from the PCS controller 250 is also obtained (step S302).

On the regulator 260b, it is determined whether or not both of the acceleration control according to the obtained ACC acceleration request or the deceleration control according to the obtained ACC deceleration request and the deceleration control according to the obtained PCS deceleration request are in operation (step S303). If it is determined that both of the control according to the ACC acceleration request or the ACC deceleration request and the deceleration control according to the PCS deceleration request are not in operation (the step S303: NO), each control may be separately performed. Thus, each of the ACC acceleration request or the ACC deceleration request and the PCS deceleration request is outputted from the regulator 260b (step S309).

On the other hand, if it is determined that both of the control according to the ACC acceleration request or the ACC deceleration request and the deceleration control according to the PCS deceleration request are in operation (the step S303: YES), it is determined whether or not the request obtained from the ACC controller 230 is the acceleration request (step S304). In other words, it is determined whether the request outputted by the ACC controller 230 is the acceleration request or the deceleration request.

If it is determined that the request obtained from the ACC controller 230 is not the acceleration request (i.e. is the deceleration request) (the step S304: NO), it is determined whether or not the ACC required deceleration is greater than the PCS required deceleration (step S305). If it is determined that the ACC required deceleration is greater than the PCS required deceleration (the step S305: YES), the ACC deceleration request is selected on the regulator 260b (step S306) and is outputted to the brake ECU 400 (the step S309). On the other hand, if it is determined that the ACC required deceleration is less than or equal to the PCS required deceleration (the step S305: NO), the PCS deceleration request is selected on the regulator 260b (step S307) and is outputted to the brake ECU 400 (the step S309). By this, the deceleration control according to the deceleration request selected in the step S306 or the step S307 is performed.

On the other hand, if it is determined that the request obtained from the ACC controller 230 is the acceleration request (the step S304: YES), the operation stop request is outputted from the regulator 260b to the ACC controller 230 (step S308). Those processes are performed if it is determined that both of the controls are in operation in the step S303. It can be thus said that the operation stop request is outputted to the ACC controller 230 if both of the acceleration control according to the ACC acceleration request and the deceleration control according to the PCS deceleration request are in operation.

Due to the operation stop request described above, the state of the ACC controller 230 is changed from the operating state to a stop state, and after that, the ACC acceleration request and the ACC deceleration request are not outputted. Thus, the ACC acceleration request and the ACC deceleration request are not obtained on the regulator 260b, and only the PCS deceleration request is obtained. As a result, only the PCS deceleration request is outputted from the regulator 260b after the operation stop of the ACC controller 230 (the step S309)

### (3-3) Effects of Embodiment

Next, the beneficial technical effects achieved by the driving support apparatus 30 according to the third embodiment will be explained in detail.

As explained in FIG. 11, according the driving support apparatus 30 in the third embodiment, if both of the deceleration control according to the ACC deceleration request and the deceleration control according to the PCS deceleration request are in operation, the deceleration request with lower required deceleration is selected. Therefore, as in the already explained first and second embodiments, it is possible to prevent that the deceleration control with lower required deceleration is performed and the driver feels uneasy due to the gravity (G) slip.

Moreover, particularly in the third embodiment, if both of the acceleration control according to the ACC acceleration request and the deceleration control according to the PCS deceleration request are in operation, the operation stop request is outputted to the ACC controller 230. Thus, after that, the ACC control is stopped, and only the PCS control is performed. This makes it possible to prevent that the acceleration control in the ACC control and the deceleration control in the PCS control are performed at the same time and brake dragging occurs.

Even if the ACC controller 230 is set in the stop state, the same effects are also obtained by the regulator 260b selecting the request not to output the ACC acceleration request. In other words, if the ACC acceleration request and the PCS deceleration request, which have overlap of execution periods, are inputted to the regulator 260b, the PCS deceleration request may be selected as a request to be outputted.

### (4) Fourth Embodiment

Next, a driving support apparatus according to a fourth embodiment will be explained. The fourth embodiment is mostly the same as, but is partially different from the already explained first, second and third embodiments in configuration and operations. Thus, hereinafter, the different part from the first, second and third embodiments will be explained in detail, and an explanation for the other same part will be omitted. Hereinafter, an explanation will be given in order, for a configuration of the driving support apparatus according to the fourth embodiment, operations of a regulator according to the fourth embodiment, operations of an engine ECU according to the fourth embodiment, and effects achieved by the driving support apparatus according to the fourth embodiment.

### (4-1) Configuration of Driving Support Apparatus

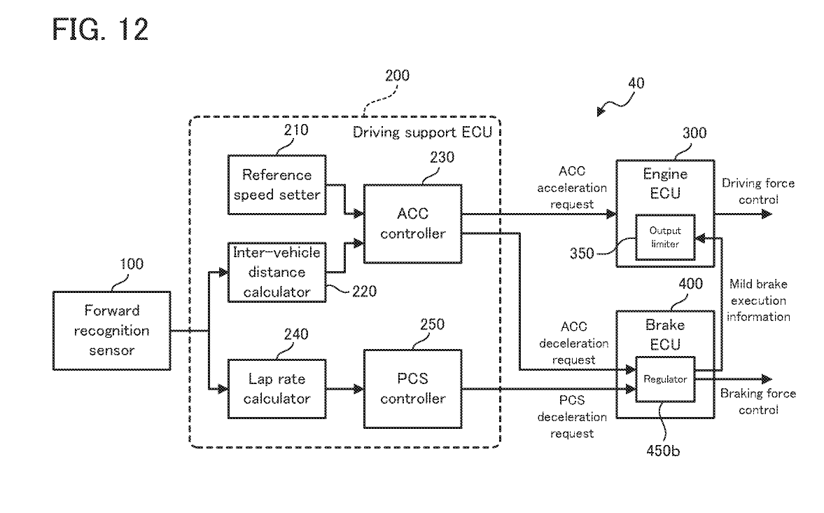

Firstly, the configuration of the driving support apparatus according to the fourth embodiment will be explained with reference to FIG. 12. FIG. 12 is a block diagram illustrating the configuration of the driving support apparatus according to the fourth embodiment.

In FIG. 12, in a driving support apparatus 40 according to the fourth embodiment, the brake ECU 400 is provided with a regulator 450b, as in the first embodiment. The regulator 450b according to the fourth embodiment, however, is partially different from the regulator 450 according to the first embodiment in configuration (refer to FIG. 1). Specifically, the regulator 450b is configured to output mild brake execution information (i.e. information about the execution of the PCS mild brake control) to an output limiter 350 of the engine ECU 300.

Moreover, in the driving support apparatus 40 according to the fourth embodiment, the engine ECU 300 is provided with the output limiter 350. The output limiter 350 is configured to limit the driving force of the self-vehicle 500 on the basis of the mild brake execution information outputted from the regulator 450b described above. The limitation of the driving force by the output limiter 350 will be described in detail in the following explanation regarding the operations.

### (4-2) Operations of Regulator

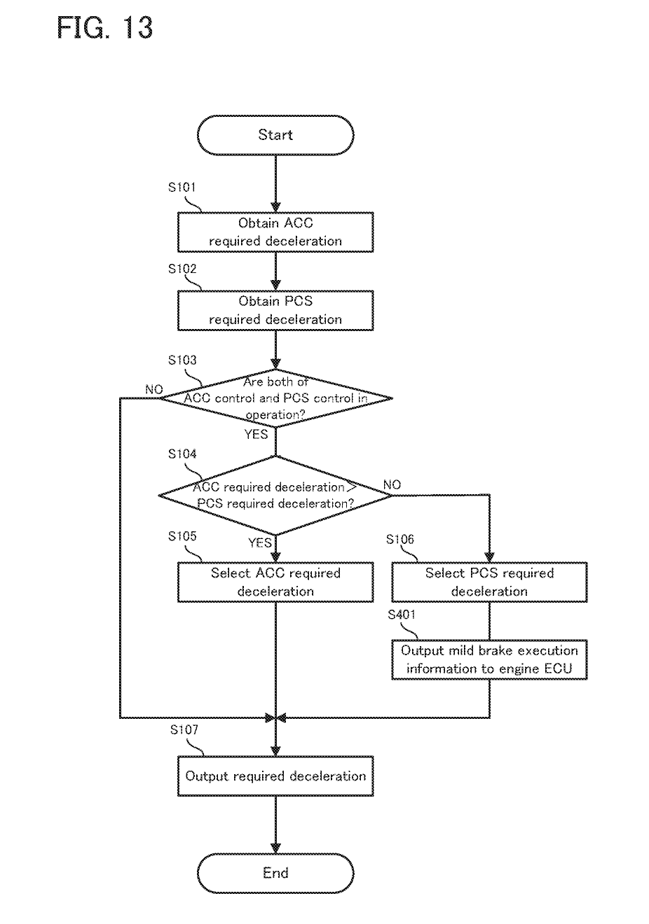

Hereinafter, the operations of the regulator 450b according to the fourth embodiment will be explained in detail with reference to FIG. 13. FIG. 13 is a flowchart illustrating operations regarding regulation or adjustment of deceleration on the driving support apparatus according to the fourth embodiment. The process illustrated in the flowchart in FIG. 13 is a process performed by the regulator 450b of the brake ECU 400. Moreover, the process performed by the regulator 450b is extremely close to the process performed by the regulator 450 according to the first embodiment. Thus, in FIG. 13, the same reference numeral will carry in the same process as in FIG. 8, and an explanation thereof will be omitted, as occasion demands.

In FIG. 13, in operation of the driving support apparatus 40 according to the fourth embodiment, if it is determined that the ACC required deceleration is less than or equal to the PCS required deceleration (the step S104: NO) and if the PCS required deceleration is selected as required deceleration to be outputted (the step S106), the mild brake execution information is outputted from the regulator 450b to the output limiter 350 (step S401). The mild brake execution information includes information indicating that the PCS mild brake is to be performed and information indicating a period in which the PCS mild brake is performed.

After the output of the mild brake execution information, the PCS required deceleration is outputted from the regulator 450b as the required deceleration of the deceleration control to be performed (the step S107). In other words, the same process as in the first embodiment is performed.

### (4-3) Operations of Engine ECU

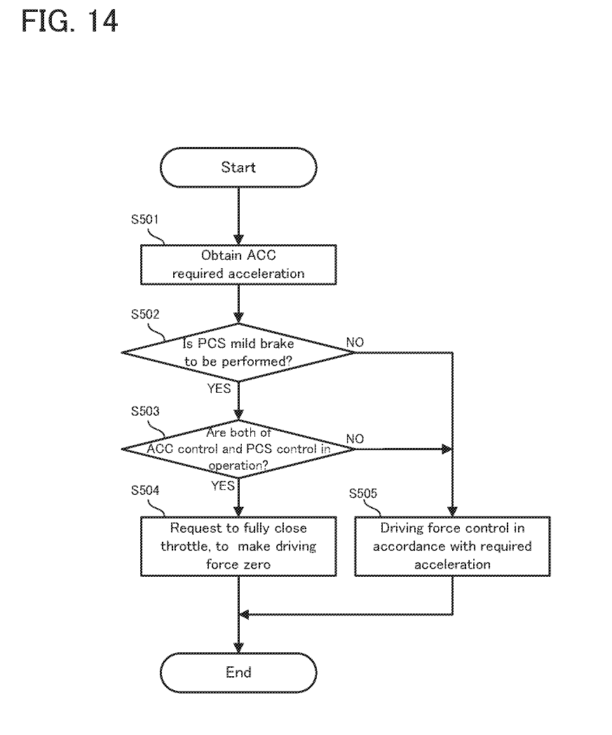

Next, the operations of the engine ECU 300 of the driving support apparatus 40 according to the fourth embodiment will be explained in detail with reference to FIG. 14. FIG. 14 is a flowchart illustrating operations regarding driving force control on the driving support apparatus according to the fourth embodiment. The process illustrated in the flowchart in FIG. 14 is a process performed by the engine ECU 300 (particularly by the output limiter 350 provided for the engine ECU 300).

In FIG. 14, in operation of the driving support apparatus 40 according to the fourth embodiment, the ACC acceleration request outputted from the ACC controller 230 is obtained on the engine ECU 300 (step S501).

If the ACC acceleration request is obtained, it is determined on the output limiter 350 whether or not the PCS mild brake is to be performed (step S502). The determination is performed on the basis of the mild brake execution information inputted from the regulator 450b of the brake ECU 400. If it is determined that the PCS mild brake is not to be performed (the step S502: NO), the driving force control of the self-vehicle 500 is performed in accordance with the ACC required acceleration indicated by the obtained ACC acceleration request (step S505).

On the other hand, if it is determined that the PCS mild brake is to be performed (the step S502: YES), it is determined on the output limiter 350 whether or not both of the acceleration control according to the ACC acceleration request and the PCS mild brake control are in operation (step S503). The determination is performed on the basis of the ACC acceleration request obtained from the ACC controller 230 and the mild brake execution information inputted from the regulator 450b. If it is determined that both of the acceleration control according to the ACC acceleration request and the PCS mild brake control are not in operation (the step S503: NO), the driving force control of the self⁻vehicle 500 is performed in accordance with the ACC required acceleration indicated by the obtained ACC acceleration request (the step S505).

If it is determined that both of the acceleration control according to the ACC acceleration request and the PCS mild brake control are in operation (the step S503: YES), the output limiter 350 requests the engine to fully close the throttle to make the driving force zero (step S504). In other words, the execution of the acceleration control according to the ACC acceleration request is substantially stopped. The control of making the driving force zero is continuously performed until the execution period of the PCS mild brake control ends. In other words, the driving force is limited to zero while the execution period of the acceleration control according to the ACC acceleration request overlaps the execution period of the PCS mild brake control.

### (4.4) Effects of Embodiment

Next, the beneficial technical effects achieved by the driving support apparatus 40 according to the fourth embodiment will be explained in detail.

As explained in FIG. 13 and FIG. 14, according the driving support apparatus 40 in the fourth embodiment, if both of the acceleration control according to the ACC acceleration request and the PCS mild brake control are in operation, the driving force is limited to zero by the output limiter 350, by which the execution of the acceleration control according to the ACC acceleration request is substantially stopped. In this manner, as in the third embodiment, it is possible to prevent that the acceleration control in the ACC control and the deceleration control in the PCS control are performed at the same time and the brake dragging occurs.

Particularly in the fourth embodiment, unlike the third embodiment, the ACC control 230 is not set in the stop state (in other words, is maintained in the operating state). It is therefore unnecessary to reset the ACC controller 230 in the operating state whenever the ACC controller 230 is set in the stop state.

In many cases, switching ON/OFF of the operation of the ACC control (i.e. switching between the operating state and the stop state of the ACC controller 230) is manually performed by the operation of the driver. Thus, if the ACC controller 230 is set in the stop state whenever the PCS control is selected, the driver needs to reset the ACC controller 230 in the operating state at each time, which is extremely troublesome and complicated. In the embodiment, however, even if the PCS control is selected, the ACC controller 230 is not set in the stop state. It is therefore possible to significantly reduce time and effort of the driver.

The invention may be embodied in other specific forms without departing from the spirit or essential characteristics thereof. The present embodiments and examples are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A driving support apparatus comprising:
a first controller configured to generate a first acceleration request to accelerate a vehicle or a first deceleration request to decelerate the vehicle, on the basis of a predetermined reference speed or an inter-vehicle distance to a preceding vehicle;
a second controller configured to generate a second deceleration request to decelerate the vehicle, on the basis of a lap rate between the vehicle and an obstacle that exists ahead of the vehicle; and
a regulator configured to compare required deceleration of the first deceleration request and required deceleration of the second deceleration request in magnitude, and to output the deceleration request with higher required deceleration, if both of first deceleration control corresponding to the first deceleration request and second deceleration control corresponding to the second deceleration request are in a condition to be performed.

2. The driving support apparatus according to claim 1, wherein said regulator does not output the first acceleration request but outputs the second deceleration request if both of first acceleration control corresponding to the first acceleration request and the second deceleration control are in a condition to be performed.

3. The driving support apparatus according to claim 1, wherein
said first controller is configured to switch between an operating state in which the first acceleration request and the first deceleration request are generated and a stop state in which the first acceleration request and the first deceleration request are not generated, and
said regulator switches a state of said first controller from the operating state to the stop state if the required deceleration of the first deceleration request is less than the required deceleration of the second deceleration request as a result of the comparison in magnitude between the required deceleration of the first deceleration request and the required deceleration of the second deceleration request.

4. The driving support apparatus according to claim 3, wherein said regulator switches the state of said first controller from the operating state to the stop state if both of the first acceleration control and the second deceleration control are in the condition to be performed.

5. The driving support apparatus according to claim 3, wherein
the state of said first controller is switched between the operating state and the stop state by an operation of a driver of the vehicle, and
said regulator changes target driving force, which is determined in accordance with the first acceleration request, to zero, until the second deceleration control is ended, while maintaining said first controller in the operating state, if both of the first acceleration control and the second deceleration control are in the condition to be performed.
